(19) United States
(12) Patent Application Publication
(10) Pub. No.: US 2006/0287006 A1
(43) Pub. Date: Dec. 21, 2006

(54) Hands-free audio system for a wireless communication device

(76) Inventors: Rick Mclntyre, South Jordan, UT (US); Corinne Mclntyre, South Jordan, UT (US); Melissa Curlis, South Jordan, UT (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/444,920

(22) Filed: Jun. 1, 2006

Related U.S. Application Data
(60) Provisional application No. 60/686,476, filed on Jun. 1, 2005.

(51) Int. Cl. H04M 1/00

(52) U.S. Cl. 455/569.1

(57) ABSTRACT

A hands-free audio system which comprises a mobile communication device case, a reel connected to said mobile communication device case, and a wire configured to be in electrical communication with a mobile communication device, wherein said wire is extendably wound about said reel.

### RELATED APPLICATIONS

This application claims the benefit under 35 U.S.C. § 119(e) of U.S. Provisional Patent Application No. 60/686,476 filed Jun. 1, 2005, titled “Hands-Free Audio System for a Wireless Communications Device.” The provisional application is incorporated herein by reference in its entirety.

### BACKGROUND

For several reasons, users of mobile communication devices such as cell phones have an increased need for hands-free audio capabilities. For example, without hands-free capabilities built into mobile communication devices, users have an increased risk of being involved in accidents while operating vehicles. In fact, in some areas of the United States, operating a vehicle while talking on a mobile communication device without a hands-free system is illegal. Additionally, hands-free capabilities provide a simple convenience while the user is involved in other tasks and needs to communicate via their mobile communication device.

It is both beneficial and convenient to always have the hands-free system on hand. However, this may require carrying the hands-free system apart from the mobile communications system.

### SUMMARY

In one of many possible embodiments, the present system and method provides a hands-free audio system including a mobile communication device case, a reel connected to the mobile communication device case, and a wire configured to be in electrical communication with a mobile communication device, wherein the wire is extendably wound about the above-mentioned reel.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a partially cutaway rear view of the phone case according to one exemplary embodiment.

FIG. 2 is a rear view of the phone case of FIG. 1, according to one exemplary embodiment.

FIG. 3 is a rear view of the phone case of FIG. 1, according to one exemplary embodiment.

Throughout the drawings, identical reference numbers designate similar, but not necessarily identical, elements.

### DETAILED DESCRIPTION

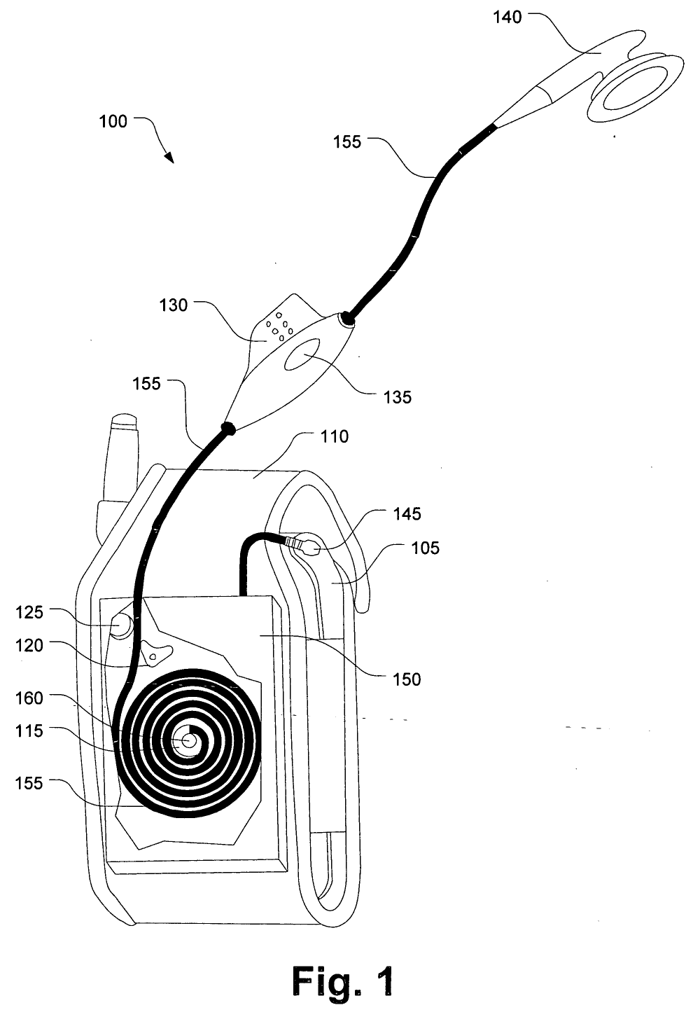

The present specification discloses a hands-free audio system (100) for a wireless communications device. More specifically, the present specification discloses a carrying case which incorporates a retractable hands-free audio system (100) for use in connection with a wireless communications device. Further details of the components of the present hands-free audio system (100) will be provided below with reference to FIGS. 1-3.

In the following description, for purposes of explanation, numerous specific details are set forth in order to provide a thorough understanding of the present system and method for providing a hands-free audio system for a mobile communication device. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment

Referring now to FIG. 1, a partially cutaway rear view of the mobile communication device case is shown. As illustrated, the mobile communications device case (110) includes a reel housing (150), containing a reel (115) configured to retractably couple a hands-free audio system (100) to the mobile communications device case (110). As illustrated in the cutaway portion of FIG. 1, the reel (115) is securely disposed in a reel housing (150), according to one exemplary embodiment. As illustrated, the reel (115) is wind-tensioned to wind a wire (155) onto the reel (115) in opposition to pulling the wire and locking the reel in a desired unwound position. The winding and unwinding of the reel (115) are accomplished, according to one exemplary embodiment, using a wire clamp (120) and a wire release (125) included in the reel housing (150). In one exemplary embodiment, the reel housing (150) has a thickness of preferably about one-quarter inch, a width not greater than a width of the mobile communication device case (110) and a length not greater than a length of the mobile communication device case.

According to one exemplary embodiment, the wire (155) has a length of preferably about three feet and can be standard phone wire that is used commonly intermediate to a phone jack and a telephone handset. However, the wire (155) may be any desirable length. According to another exemplary embodiment, the wire (155) can be customized phone wire having an insulated outside perimeter that is circumferential with a diameter of approximately two millimeters and contains all standard phone-wire lines with a predetermined amount of insulation. In one embodiment, the wire (155) receives and transmits sound in connection with a mobile communication device (105) to which it is electronically coupled. The reel end of the wire (155) may be attached to a reel axle (160) onto which the wire is wound, according to the illustrated embodiment. The reel axle (160) may then be wind-tensioned to wind the wire (155) onto the reel (115) in predetermined opposition to pulling the wire and locking the reel axle in a selectively unwound position. In one exemplary embodiment, the reel axle (160) may be wind-tensioned with an electrical motor. In another embodiment, the reel axle (160) may be wind-tensioned with a mechanical spring.

Continuing with FIG. 1, the wire clamp (120) and a wire release (125) make it possible for a user to pull the wire (155) out of the reel (115) to a desired length. Then, according to one exemplary embodiment, when the user is finished communicating via the hands-free system (100), the user may pull on the wire (155) to release the wire clamp, allowing the wire to begin to wind back onto the reel (115). In another exemplary embodiment, the user may retract the wire (155) back onto the reel (115) by pressing a button that activates the wire release (125) and allows the wind-tension of the reel to reel the wire back onto the reel. In yet another embodiment, the winding of the wire (155) back onto the reel (115) may be done electronically via a motor attached to the reel (115).

FIG. 1 further illustrates a microphone (130) and an ear piece (140) that are electronically coupled to the wire (155) to allow the user to both speak and listen as one would through a telephone. The microphone (130) may also be deactivated by use of an on/off switch (135) disposed on the electronically coupled wire (155). Once the on/off switch (135) is deactivated, the user's voice may not be transmitted. In one possible embodiment, the action of reeling out the wire (115) to a predetermined length may activate the microphone (130) and ear piece (140).

According to the present exemplary hands-free audio system (100), the ear piece (140) is any type of speaker device that allows the user to hear communications being received by his or her mobile communication device (105). More specifically, according to one exemplary embodiment, the ear piece (140) may be an ear bud that fits snuggly into the outer ear of a user.

Additionally, the wire (155) may include a connector (145) located on the wire at the opposite end of the ear piece (140) and microphone (130). The connector (145) is configured to be coupled to the mobile communication device's hands-free audio system port. The amount of wire (155) allotted between the connector (145) and the reel (115) is adjustable and determined by where the mobile communication device's hands-free audio system port is.

Several different configurations of mobile communication devices (105) require different types of connectors (145) for their hands-free audio system ports. Consequently, different types of connectors are available and can be installed onto a pre-consumer hands-free audio system (100). Electronic adaptors can also be supplied to the consumer at the point of sale to allow several different types of mobile communication devices (105) to connect to the hands-free audio system (100).

In one exemplary embodiment, the mobile communication device (105) is a cellular phone. However, the mobile communication device (105) can be any audio and/or visual communications device including, but not exhaustive of a personal digital assistant (PDA), an MP3 player such as an Apple iPod, or a handheld computer.

As illustrated, the mobile communication device case (110) is intricately connected to the reel housing (150) so as to conveniently make the ear piece (140) and microphone (130) accessible to the user. The mobile communication device case (110) is a case that is used to conveniently transport a mobile communication device (105) in order to protect and secure the mobile communication device (105).

In one exemplary embodiment, the mobile communication device case (110) is made of leather. Also, as was mentioned above, several different types of mobile communication devices (105) exist, each of the various mobile communication devices having different sizes and shapes. Consequently, the mobile communication device case (110) can be designed specifically for any number of particular mobile communication devices (105). However, the mobile communication device case (110) can also be adjustable to fit different mobile communication devices (105).

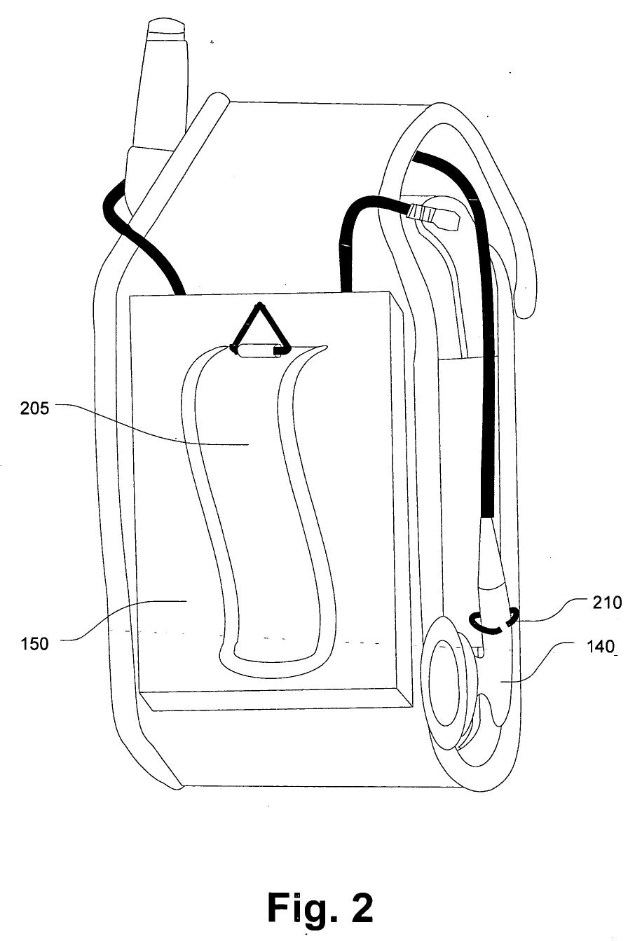

FIG. 2 is a rear view of a phone case according to one exemplary embodiment. As illustrated, a case clip (205) may be connected to the reel housing (150). In one embodiment, the case clip (205) is made of a metal. The incorporation of a case clip (205) allows for a degree of spring so that the user can securely attach the mobile communication device case (110; FIG. 1) to his or her belt or other clothing or accessory while holding the mobile communication device case (110; FIG. 1) to the article of clothing. In another embodiment, the case clip (205) may be made of any semi-rigid material such as plastic. Also, the case clip (205) may be designed according to specific needs of varying types and sizes of mobile communication devices (105; FIG. 105).

An ear piece clip (210) is also provided on the side of the mobile communication device case (110; FIG. 1). When the hands-free system (100) is not in use, the user may clip the ear piece (140; FIG. 1) into an ear piece clip (210). This allows the ear piece (140; FIG. 1) to not get damaged or become entangled in any way. In one embodiment, the ear piece clip (210) is a plastic clip attached to the outside of the mobile communication device case (110; FIG. 1). However, the ear piece clip may be any type of fastener that will secure the ear piece (140; FIG. 1) to the mobile communication device case (110; FIG. 1).

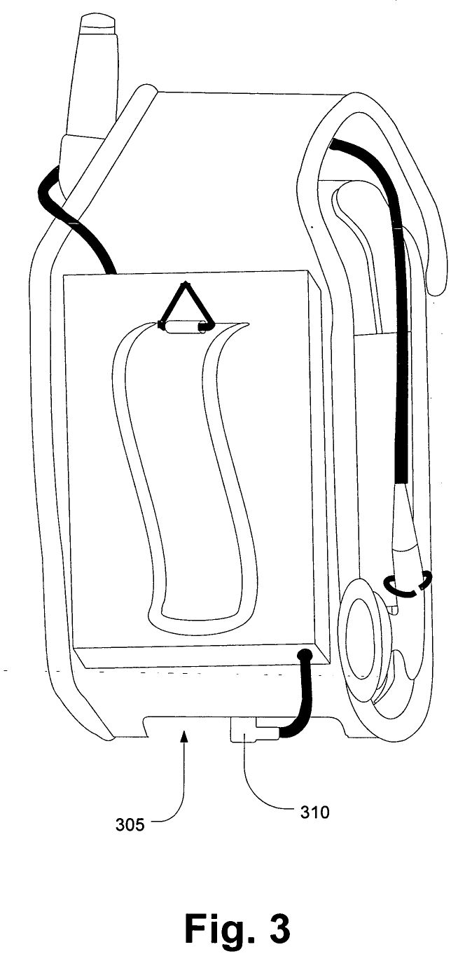

FIG. 3 is a rear view of the phone case according to one exemplary embodiment. In one embodiment, an opening (305) is provided to allow access to the mobile communication device's hands-free audio system port. Often times, mobile communication devices (105; FIG. 1) have hands-free audio system ports located at the bottom of the device. To allow the hands-free audio system's connector (305) access to these ports, an opening (305) is provided. As previously mentioned, the amount of wire (155; FIG. 1) allotted between the connector (145; FIG. 1) and the reel (115; FIG. 1) is adjustable and determined by the location of the mobile communication device's hands-free audio system port.

In conclusion, the present hands free system and its associated case provide a hands-free system that is intricately connected to the carrying case of a mobile communication device, thereby increasing convenience while using the hands-free system. Additionally, the present exemplary system and method provides a carrying case that allows the user to use such a carrying case for several different mobile communication devices if necessary. More specifically, if a user changes communication devices, the present exemplary carrying case will include the present hands-free system, thereby eliminating the cost of having to buy a new hands-free audio system should the user replace his or her mobile communication device.

The preceding description has been presented only to illustrate and describe embodiments of the present system and method. It is not intended to be exhaustive or to limit the present system and method to any precise form disclosed. Many modifications and variations are possible in light of the above teaching.

What is claimed is:

1. A hands-free audio system comprising:
a mobile communication device case;
a reel connected to said mobile communication device case; and
a wire configured to be in electrical communication with a mobile communication device;
wherein said wire is extendably wound about said reel.

2. The hands-free audio system of claim 1, wherein said hands-free audio system comprises a microphone.

3. The hands-free audio system of claim 1, wherein said hands-free audio system comprises an ear piece.

4. The hands-free audio system of claim 1, wherein said mobile communication device case is made of leather.

5. The hands-free audio system of claim 1, wherein said mobile communication device case is designed to accommodate said mobile communication device.

6. The hands-free audio system of claim 1, wherein said mobile communication device case further comprises an ear piece clip coupled thereto;
wherein said ear piece clip is configured to secure an ear piece to said mobile communication device case.

7. The hands-free audio system of claim 1, wherein said mobile communication device case further comprises an opening configured to be located proximate to a communication port of said mobile communication device, when said mobile communication device is disposed in said device case.

8. The hands-free audio system of claim 1, wherein said mobile communication device case further comprises a mobile communication device case clip coupled thereto;
wherein said mobile communication device case clip is configured to securely couple said mobile communication device case to a substantially planar article.

9. The hands-free audio system of claim 1, wherein said wire is wound about said reel via one of a wind-tensioned mechanical spring or an electric motor.

10. The hands-free audio system of claim 1, wherein said mobile communication device comprises one of a cellular phone, a personal digital assistant (PDA), an MP3 player such as an Apple iPod, or a handheld computer.

11. A method of forming a hands-free audio system, said method comprising securing said hands-free audio system to a mobile communication device case.

12. The method of claim 11, wherein securing said hands-free audio system to a mobile communication device case comprises providing an orifice configured to house a reel portion of said hands-free audio system.

13. The method of claim 12, further comprising disposing said reel portion of said hands-free audio system in said orifice.

14. The method of claim 13, wherein said reel portion of said hands-free audio system is removably disposed in said orifice.

15. The method of claim 11, further comprising securing said hands-free audio system to an outside of said mobile communication device case.

16. The method of claim 11, wherein said hands-free audio system is secured to an inner portion of said mobile communication device case.

17. The method of claim 11, further comprising securing an ear piece clip to an outer surface of said mobile communication device case.

18. The method of claim 11, further comprising forming an opening in said mobile communication device case;
said opening being configured to provide external access to a communication port of a mobile communication device when disposed in said mobile communication device case.
